(19) United States
(12) Patent Application Publication
(10) Pub. No.: US 2004/0126054 A1
(43) Pub. Date: Jul. 1, 2004

(54) Absorption matched ring resonation modulator/switch priority

(76) Inventor: Giora Griffel, Tenafly, NJ (US)

Correspondence Address: DUANE MORRIS LLP, 100 COLLEGE ROAD WEST, SUITE 100, PRINCETON, NJ, 08540-6604, US

(21) Appl. No.: 10/204,157

(22) PCT Filed: Feb. 23, 2001
(86) PCT No.: PCT/US01/05716

(51) Int. Cl. G02B 6/26; G02B 6/42

(52) U.S. Cl. 385/15

(57) ABSTRACT

Optical switches and modulators contain a single-mode waveguide (401) and at least one closed-loop resonator (402). The single-mode waveguide (401) is optically coupled to the closed-loop resonator (402), and the light propagating in the single-mode waveguide (401) is modulated by applying an inducing effect, e.g. optically pumping, to the closed-loop resonator (402) so as to vary the effective propagation loss in the closed-loop resonator. Alternatively, the optical signal propagating in the single mode waveguide (401) is modulated by applying an inducing effect, e.g. electro-optics, to vary the coupling between the single-mode waveguide and the closed loop resonator (402).

This application claims priority to Provisional Application No. 60/184,317, filed Feb. 23, 2000, and which is incorporated herein by reference.

### FIELD OF THE INVENTION

The present invention relates to optical switches. In particular, the present invention relates to ring-resonator modulators and switches.

### BACKGROUND

Known ring resonator channel-dropping filters often include a ring that is etched into a light-guiding material, and placed between two straight light-guiding channels. FIG. 1 is a schematic representation of such a filter. In this configuration, waveguide 101 is optically coupled to ring resonator 102. Ring resonator 102 is optically coupled to waveguide 103. Thus, as light travels from left to right (in the orientation in FIG. 1) through waveguide 101, if conditions permit, the light is coupled into ring resonator 102. As light travels around ring resonator 102, under the proper conditions, the light couples into waveguide 103. Specifically, under resonance conditions, the ring resonator allows all the light traveling through waveguide 101 to be coupled into waveguide 103 where it propagates in the opposite direction. Thus, one can envision a frequency-dependent “coupler” where waveguide 101 optically couples to ring resonator 102, and where ring resonator 102 optically couples to waveguide 103.

FIG. 2 is a graphical representation of intensity of the light coupled from waveguide 101 into waveguide 103 through the ring resonator 102 as a function of frequency. The graph assumes a lossless system with identical coupling between ring resonator 102 and waveguide 101, and ring resonator 102 and waveguide 103. The intensity Transmission is represented as Iₜ/Iᵢₙ, where Iₜ is the intensity of the light transmitted into waveguide 103, and Iᵢₙ is the intensity of the light as it approaches the ring resonator in waveguide 101. As can be seen from FIG. 2, assuming a lossless system, the ratio Iₜ/Iᵢₙ is unity at the resonant frequencies.

FIG. 3 is a graphical representation of the intensity Reflection in waveguide 101 as a function of frequency, i.e. the intensity of light that continues propagating in waveguide 101 after passing the ring resonator 102. Again, the graph in FIG. 3 assumes a lossless system with identical coupling between ring resonator 102 and waveguide 101, and ring resonator 102 and waveguide 103. The intensity Reflection is represented by Iₜ/Iᵢₙ, where Iₜ is the intensity of the light after it passes nearby the ring modulator in waveguide 101, and Iᵢₙ is the intensity of the light as it approaches the ring resonator in waveguide 101. This graph is complementary to the graph in FIG. 2; that is, the reflection dips in FIG. 3 occur at the same frequencies that display peaks in FIG. 2, such that the sum of the curves in FIG. 2 and FIG. 3 is unity throughout the entire spectrum. Thus, when the Transmission intensity is unity, the Reflection intensity is zero.

Additionally, the amount of light transmitted from waveguide 101 to waveguide 102 can be modulated in various ways. For example, the loss within the ring resonator can be varied; the refractive index of the ring resonator can be varied; and the coupling into the ring from one of the waveguides with respect to the coupling to and from the other waveguide can be altered. In practice, however, realizing a completely lossless system is virtually impossible, and manufacturing a structure with identical waveguides (i.e., with identical couplers) is extremely complicated.

With regard to losses in the ring itself, the sources of loss in the ring include bending loss (which can be made small enough for deeply etched or large index step waveguides), material loss due to optical absorption, scattering loss due to wall roughness, leakage to the substrate, and mode-matching loss. For the purposes of the present invention, the sum of all the losses in the ring is called the “effective propagation loss.”

Of all the loss mechanisms, the mode-matching radiative loss that occurs at the transition from the single-mode channel (i.e., the portion of the ring 102 which is far enough from the coupling region) to the double-mode-coupling region appears to be the most significant. This loss can render such devices impractical due to high insertion loss.

Thus, a need exists for an optical modulator/switch with minimal loss.

### SUMMARY OF THE INVENTION

To alleviate the problems inherent in the prior art, embodiments of the present invention are directed to low-loss optical switches and modulators. In one embodiment of the present invention, an apparatus includes a single-mode light guide, a ring resonator optically coupled to the single-mode light guide, and a means of varying the effective propagation loss in the ring resonator. Such means may include, for example, a variable voltage or current source coupled to the ring resonator to control the gain or loss in said ring resonator so as to vary the effective propagation loss in the ring resonator.

Optical switches and modulators contain a single-mode waveguide and at least one closed-loop resonator. The single-mode waveguide is optically coupled to the closed-loop resonator, and the light propagating in the single-mode waveguide is modulated by applying an inducing effect, e.g. optically pumping, to the closed-loop resonator so as to vary the effective propagation loss in the closed-loop resonator. Alternatively, the optical signal propagating in the single-mode waveguide is modulated by applying an inducing effect, e.g. electro-optics, to vary the coupling between the single-mode waveguide and the closed loop resonator.

### BRIEF DESCRIPTION OF THE DRAWING.

FIG. 1 is a schematic representation of a known configuration of a ring resonator filter.

FIG. 2 is a graphical representation of the transmission intensity as a function of frequency in a lossless system with identical waveguides.

FIG. 3 is a graphical representation of the reflection intensity as a function of frequency in a lossless system with identical coupling between the ring resonator and the two straight waveguides.

FIGS. 4A-4D represent embodiments of the present invention displaying a waveguide, a ring resonator and a control or actuator source.

FIG. 5 is a graphical representation of transmission intensity through the single-mode waveguide 401 as a function of frequency. FIG. 6A is a graphical representation of the transmission T_{R} as a function of α, the effective loss coefficient.

FIG. 6B is a graphical representation of transmission measured in decibels as a function of α, the effective loss coefficient.

FIG. 7 is a schematic representation of an embodiment of the invention that includes a light guide and a substantially linear array of ring resonators.

FIG. 8A is a graphical representation of transmission spectra according to an embodiment of the present invention that ‘includes a linear array of ring resonators.

FIG. 8B is a graphical representation of transmission spectra according to an embodiment of the present invention that ‘includes a single ring resonator.

FIG. 9 is a graphical representation of transmission at resonance as a function of α, the effective loss coefficient according to an embodiment of the present invention that includes a linear array of ring resonators.

FIG. 10 is a s schematic representation of an embodiment of the invention that includes a light guide and an array of ring resonators.

FIG. 11 is a schematic representation of an embodiment of the present invention in which the ring resonators are stacked vertically above the light guide.

FIG. 12 is a schematic representation of an embodiment of the present invention in which the ring resonators are stacked vertically above the light guide in a non-cylindrical configuration.

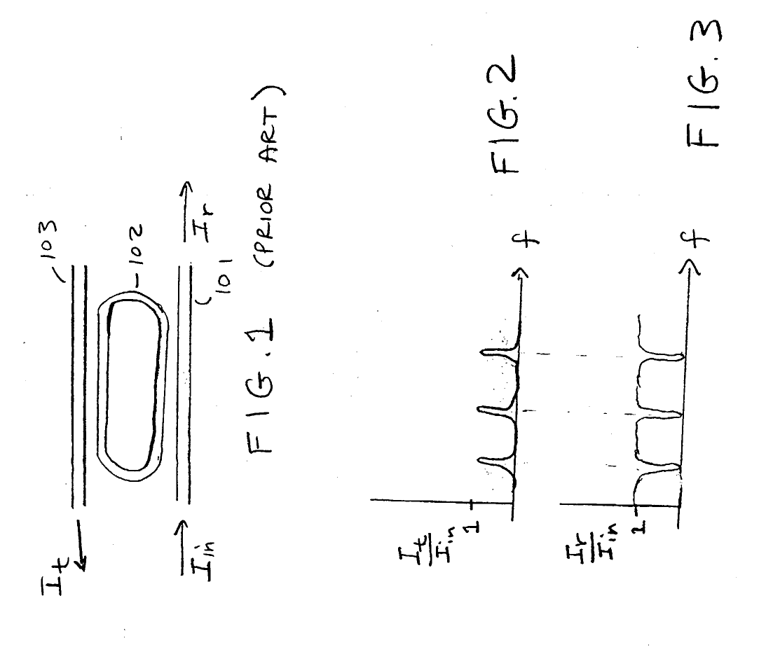

### DETAILED DESCRIPTION

Embodiments of the present invention provide an optical modulator or switch comprising a ring resonator coupled to a single input/output waveguide. Modulation of light propagating in the waveguide adjacent to the ring resonator is performed by either varying the ring resonator's effective propagation loss or by varying the amount of light coupling to the ring resonator.

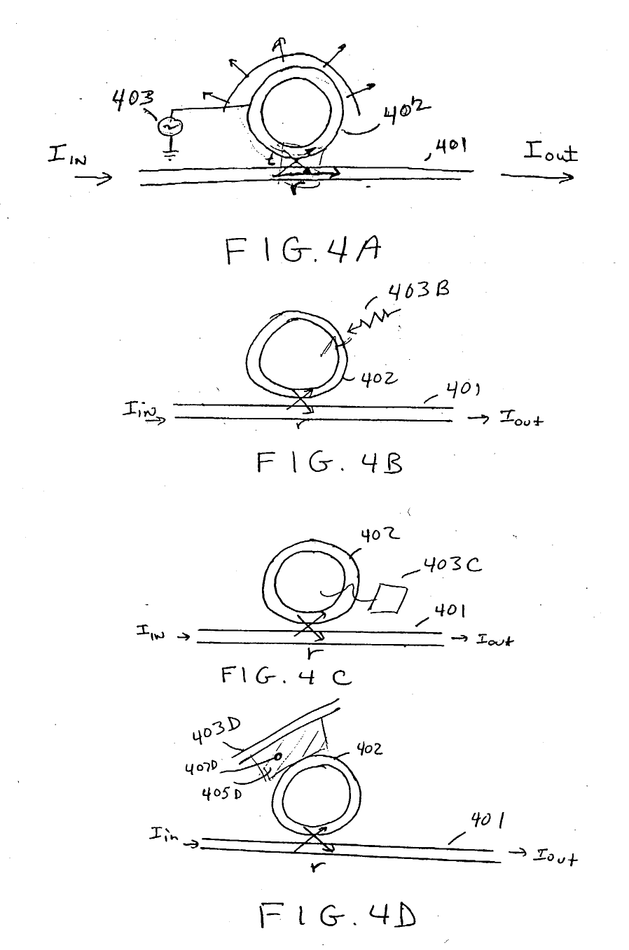

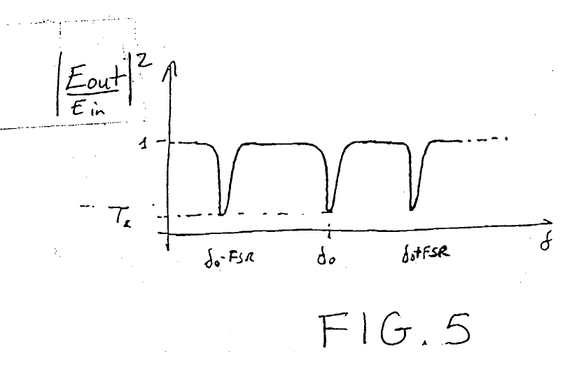

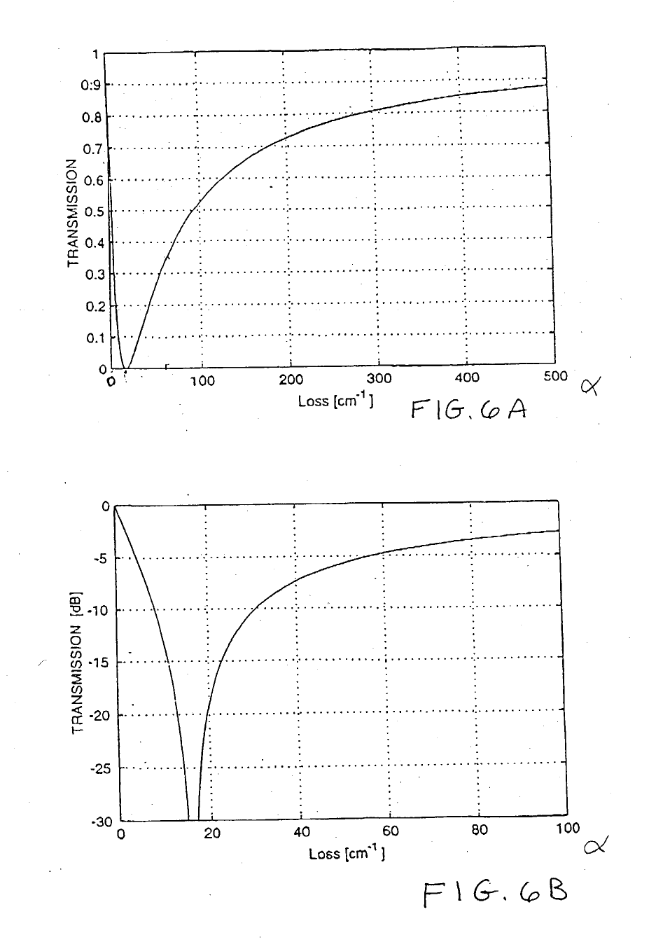

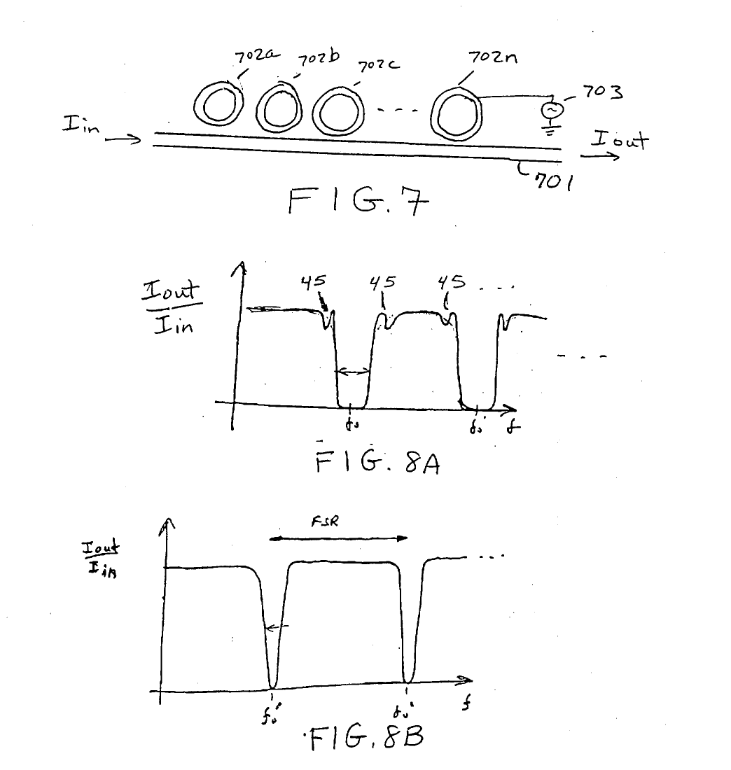

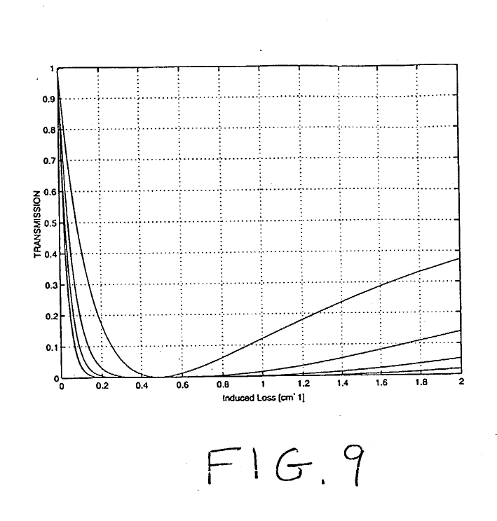

FIG. 4A is an embodiment of the present invention displaying a waveguide, a ring resonator and a means for varying the ring resonator's effective propagation loss such as an electrical source. For the purposes of the present invention, the term “electrical :source” is defined to include a current source, variable or otherwise, or a voltage source, variable or otherwise, or some combination of current and voltage sources, variable or otherwise. Other means for varying the ring resonator's effective propagation loss include optical pumping via an optical signal 403B, as shown in FIG. 4B, an object 403C (e.g. a mechanically movable object such as a semiconductor, metal or dielectric material) sufficiently close to the outer wall of the ring to cause or induce light scattering (see FIG. 4C), or another channel 403D spaced sufficiently close to the ring to enable one to control the amount of light out of the ring through that channel (see FIG. 4D). Note that such control may be accomplished via an electro-optical effect such as a change in voltage or via a fluid medium 405D as shown disposed between channel 403D and ring 402 and having a different refractive index (different than n=1 for example) to induce loss (or gain) during the round trip. This may be accomplished via fluid injection through a small opening 407D in the gap between the ring resonator and the waveguide channel 403D to increase the refractive index so as to induce loss by increasing the coupling from the ring 402 to the channel 403D. As shown in FIGS. 4A-4D, single-mode light guide 401 is optically coupled to ring resonator 402. Ring resonator 402 has an effective propagation loss, as defined above. The means for varying such as variable electrical source 403 is coupled to ring resonator 402 in a way that alters the gain or the loss of the ring resonator so as to vary the effective propagation loss in the ring resonator.

As discussed above, ring resonator 402 has an effective propagation loss. Because of the geometry in embodiments of the present invention, this effective propagation loss can be significantly smaller than the propagation loss of the known system described above. Specifically, if the single-mode waveguide 401 is the only waveguide (apart from ring resonator 402), then in one trip around ring resonator 402, light propagates only through one coupling region rather than two, as in the embodiments described above. Note that while a circular ring structure has been shown, other forms of closed loop resonators can achieve substantially the same function, such as oval, racetrack, triangle, square, polygon or other loops comprised of connected segments having different radii.

In one embodiment of the present invention, the device includes a voltage or current source that can increases or decreases the effective propagation loss in the ring by making use of one or a combination of various phenomena. These phenomena can be known phenomena, such as electrical-carrier absorption, or quantum effects such as the Quantum Confined Stark Effect (QCSE). Alternatively, these phenomena can be phenomena that are not presently known or understood. Note that it is also possible to effectively change the propagation loss in the ring to compensate for the inherent loss in the ring by adding a sufficient amount of gain up to a point of transparency, as can be illustrated in the figures.

The transmission of light propagating in waveguide 401 across the ring resonator, as a function of the loss in the ring resonator, can be modeled by equation 1.

$${\vert \frac{{E}_{0}}{{E}_{1}} \vert}^{2} = \frac{{( r - L )}^{2} + 4 {Sin}^{2} \frac{φ}{2}}{{( 1 - rL )}^{2} + 4 rL {Sin}^{2} \frac{φ}{2}} \qquad ( 1 )$$

Where

r is a feed-through or reflection coefficient describing the amount of electrical field remaining in the input waveguide after propagating a single pass through the directional coupler,

L is the loss; in one round trip and is defined as e^{-αLa/2},

α is the effective intensity loss coefficient,

Lₐ=2 Rₐ where Rₐ is the ring circumference,

Ø=βLₐ, and

β is the propagation constant of the mode circulating in the ring.

FIG. 5 is a graphical representation of transmission intensity through the single-mode waveguide 401 as a function of frequency, according to an embodiment of the present invention. The transmission at resonance is found using equation 1 by setting the term Sin²(φ/2) equal to zero. Thus,

$$TR = {( \frac{r - L}{1 - rL} )}^{2} \qquad ( 2 )$$

As can be seen from equation 2, if the loss in one trip around the ring resonator matches the feed-through coefficient of the input coupler (i.e., r=L), then the transmission at resonance T_{R} will be zero. Reducing the loss to transparency (L=>1) results in unity transmission, T_{R}=1, while increasing the loss (L=>0) will increase the value of T_{R}, asymptotically to T_{R}=r². Alternatively, the transmission T_{R} can-be varied by keeping the effective loss constant while varying the feed through coefficient, e.g. by applying voltage across the coupling region.

FIG. 6A is a graphical representation of transmission T_{R} as a function of α, the effective loss coefficient. FIG. 6B is a graphical representation of transmission measured in decibels as a function of α, the effective loss coefficient. From the two figures, one can see that a value exists for loss that causes the transmission to be exactly zero. As the loss increases further, the transmission increases asymptotically to the value of r².

FIG. 7 is a schematic representation of an embodiment of the invention that includes a light guide 701 and a substantially-linear array of ring resonators 702a, 702b, . . . 702n. For the purposes of the present invention, the phrase substantially linear in this context means that ring resonators 702a . . . 702n are periodically spaced in the longitudinal direction while being roughly equidistant from light guide 701. In one embodiment of the present invention, one of the ring resonators, say ring resonator 702n, is connected to an electrical source 703. This electrical source is coupled to ring resonator 702n to control the gain or loss in said ring resonator so as to vary the effective propagation loss in the ring resonator. It should be appreciated by one skilled in the art that electrical source 703 (and other means for varying discussed herein) can be coupled to any number of the ring resonators, or all the ring resonators. Additionally, each ring resonator can be individually coupled to a distinct electrical source (not shown). This allows for varying the effective propagation loss in any combination of the ring resonators in the array, thereby allowing for different transmission properties of the invention.

FIG. 8A is a graphical representation of transmission property according to an embodiment of the present invention in which all the ring resonators in the linear array are substantially identical, and all the ring resonators in the linear array are coupled to the same voltage source. As can be seen in this figure, the transmission as a function of frequency exhibits dips centered at the resonance frequencies of the identical ring resonators, but the dips are broader (i.e., across a range of frequencies) than in the case of a single ring resonator as shown in FIG. 8B. Note that sidelobes 45 illustrated in FIG. 8A are a result of coupling between rings 702a . . . 702n in the array. This coupling can occur directly between the rings or as a result of coupling with another waveguide. Note further that these sidelobes are effectively eliminated when no coupling between the rings occurs.

In one embodiment of the present invention, all the ring resonators are configured so as to be substantially identical with regard to certain properties (or as identical as can be practically achieved). For example, the ring resonators can be configured so as to exhibit substantially-identical optical or electrical properties, or optical-loss properties, or effective-propagation-loss properties. In another embodiment of the present invention the ring resonators are not all configured so as to be substantially identical with regard to these properties.

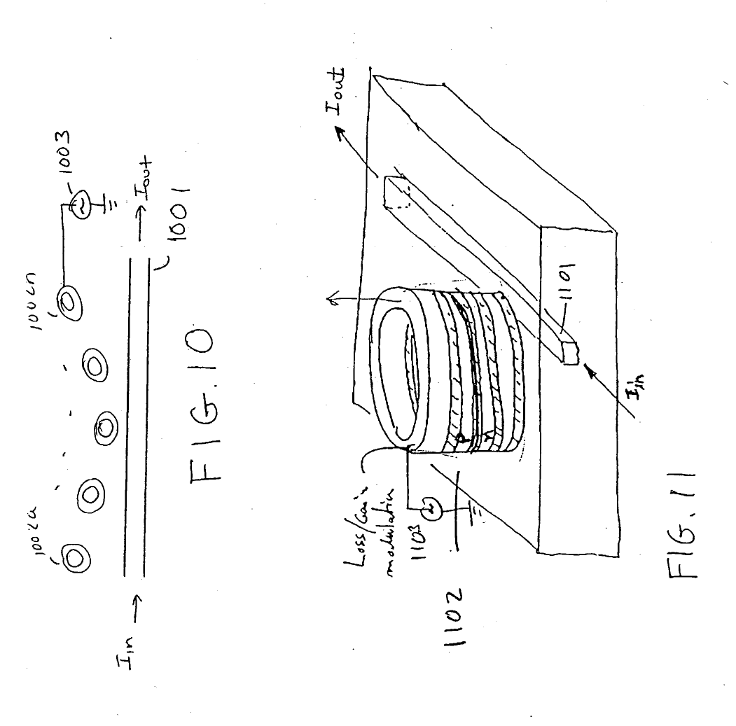

FIG. 9 is a graphical representation of transmission at resonance as a function of α, the loss coefficient according to an embodiment of the present invention that includes a linear array of ring resonators. It is shown that not only the transmission spectra exhibits broader transmission dips with flat bottom for multiple linear array with respect to a single-ring modulator, as demonstrated in FIG. 8, but the turn off voltage (or the induced loss required for reducing the transmission in the waveguide 701 to a predetermined level, e.g. 10%) can be reduced significantly by aggregating several identical ring resonators alongside the input/output waveguide. This is accompanied by a broader voltage range for which the transmission can be turned off. It is notable that the enhancement is limited with diminishing returns after a few rings.

FIG. 10 is a schematic representation of an embodiment of the invention that includes a waveguide 1001 and an array of ring resonators 1002a, 1002b, . . . 1002n. In this embodiment, the ring resonators are not all equidistant from waveguide 1002. In one embodiment of the present invention, one of the ring resonators, say ring resonator 1002m, is connected to electrical source 1003 (or other means for varying the loss in the ring as previously described). This electrical source is coupled to ring resonator 1002m in a way that optically pumps the ring resonator so as to vary the effective propagation loss in the ring resonator. It should be appreciated by one skilled in the art that variable electrical source. 1003 can be coupled to any number of the ring resonators, or all the ring resonators. Additionally, each ring resonator can be individually coupled to a distinct variable electrical source (not shown). This allows for varying the effective propagation loss in any combination of the ring resonators in the array, thereby allowing for different transmission properties of the invention.

Spectral response characteristics such as the width of the stop-band and side lobe suppression can be controlled by the transmission of the couplers to the resonators, by the intermediate coupling between the resonators, and by apodizing the transmission over the array.

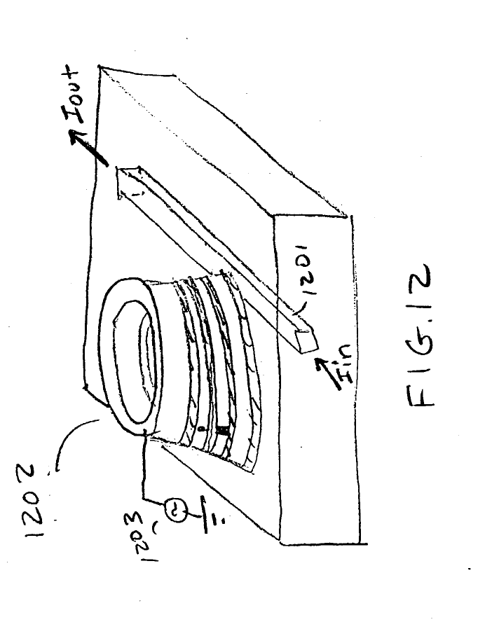

FIG. 11 is a schematic representation of an embodiment of the invention that includes light guide 1101, and a stack of rings 1102 that has an axial direction vertical to light guide 1101. In one embodiment of the present invention, light is coupled vertically from waveguide 1101 to the stack of rings. The rings comprising the stack can be identical in thickness or not, equally distant from each other or not, and have substantially-identical properties, e.g. refractive index, or not. The vertical configuration of the stack will determine the spectral characteristics of the transfer function. In one embodiment of the present invention, there is a p-n junction located within the vertical stack of ring resonators and means for varying the effective propagation loss such as electrical source 1103 coupled to the ring resonator stack to control the gain or loss in the ring resonator stack so as to vary the effective propagation loss. It should be appreciated by one skilled in the art that the p-n junction can be placed within any of the guiding layers, or close enough to induce an effective change in the propagation loss of the modes guided within the rings to enable switching operation. As noted above, it should be appreciated that the ring structure may be periodically spaced (or non-periodically spaced rings for tailoring to a specific spectral response) so as to produce a flatband characteristics of the transmission due to the multiple modes of the vertical structure as opposed to the single vertical mode of a single ring.

FIG. 12 is a schematic representation of an embodiment of the invention that includes light guide 1201, and a stack of rings 1202 that has an axial direction vertical to light guide 1201. In this embodiment, the stack of rings has a non-cylindrical, e.g. a substantially-conical, shape, such that the rings in the stack will have different radii.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims. It should also be noted that the coupling between the I/O channel and the rings can be achieved in different ways, e.g. laterally, vertically with the I/O channel buried below the rings, or laterally with an intermediate material agent (e.g. fluid or other material) between the I/O waveguide and the rings. Other configurations for coupling can be used for constructing the invention described herein.

What is claimed is:

1. An apparatus comprising:
(a) a single-mode waveguide;
(b) a closed-loop resonator optically coupled to said single-mode waveguide, said closed-loop resonator having an effective propagation loss; and
(c) an actuating source applied to said ring resonator so as to vary the effective propagation loss in said closed-loop resonator.

2. The apparatus of claim 1, wherein said actuating source is an electrical source.

3. The apparatus of claim 2, wherein said electrical source is variable.

4. The apparatus of claim 2, wherein said electrical source is not variable.

5. The apparatus of claim 1, wherein said actuating source is an optically inducing signal.

6. The apparatus of claim 1, wherein said actuating source is a light scattering movable object sufficiently close to said closed-loop resonator to induce said light scattering.

7. The apparatus of claim 1, wherein said actuating source comprises another waveguide having a fluid introduced between said another waveguide and said closed-loop resonator.

8. The apparatus of claim 1, wherein said closed-loop resonator has a substantially racetrack configuration.

9. The apparatus of claim 1, wherein said closed-loop ring resonator has a substantially oval configuration.

10. The apparatus of claim 1, wherein said closed-loop ring resonator has a substantially circular configuration.

11. The apparatus of claim 1, wherein said closed-loop ring resonator has a substantially rectangular configuration.

12. The apparatus of claim 1, wherein said closed-loop ring resonator is substantially laterally disposed substantially relative to said single-mode waveguide.

13. The apparatus of claim 1, wherein said closed-loop ring resonator is substantially vertically disposed relative to said single-mode waveguide.

14. The apparatus of claim 1, wherein said closed-loop ring resonator supports a single vertical mode.

15. The apparatus of claim 1, wherein said closed-loop ring resonator supports multiple vertical modes.

16. An apparatus comprising:
(a) a single-mode waveguide;
(b) a closed-loop resonator optically coupled to said single-mode waveguide, said closed-loop resonator having an effective propagation loss; and
(c) an actuating source for varying the coupling between said single mode waveguide and said closed-loop resonator.

17. The apparatus according to claim 16, wherein said actuating source for varying the coupling includes an electrical source.

18. The apparatus according to claim 16, wherein said actuating source for varying the coupling includes an optically inducing signal.

19. The apparatus according to claim 16, wherein said actuating source for varying the coupling includes another waveguide having a fluid introduced between said another waveguide and said closed-loop resonator.

20. An apparatus comprising:
(a) a single-mode waveguide;
(b) a plurality of closed-loop resonators forming an array along said single-mode light guide, and optically coupled to said single-mode light guide, each closed-loop resonator in said plurality of closed-loop resonators having an effective propagation loss; and
(c) an actuating source coupled to at least one of said plurality of closed-loop resonators so as to vary the effective propagation loss in said closed-loop resonator.

21. The apparatus of claim 20, wherein each said ring supports a single vertical mode.

22. The apparatus of claim 20, wherein at least one said ring supports multiple vertical modes.

23. The apparatus of claim 20, wherein said actuating source is an electrical source.

24. The apparatus of claim 23, wherein said electrical source is variable.

25. The apparatus of claim 23, wherein said electrical source is not variable.

26. The apparatus of claim 20, wherein said actuating source is an optically inducing signal.

27. The apparatus of claim 20, wherein said actuating source is a light scattering movable object sufficiently close to said ring resonator to induce said light scattering.

28. The apparatus of claim 20, wherein said actuating source comprises another waveguide having a fluid coupled between said another waveguide and said ring resonator.

29. The apparatus of claim 20, wherein each said closed-loop ring resonator is substantially identical.

30. The apparatus of claim 20, wherein said closed-loop ring resonators are periodically spaced relative to one another.

31. The apparatus of claim 20, wherein said closed-loop ring resonators are non-periodically spaced relative to one another.

32. The apparatus of claim 20, wherein each said closed-loop ring resonator is disposed at a substantially same distance from said single mode waveguide.

33. The apparatus of claim 20, wherein at least one of said closed-loop ring resonators is disposed at a distance from said single mode waveguide different than a distance associated with another of said closed-loop ring resonators from said single mode waveguide.

34. The apparatus of claim 20, wherein said closed-loop ring resonators are not identical.

35. An apparatus comprising:
(a) a single-mode waveguide with a propagation axis;
(b) a stack of closed-loop resonators having a longitudinal axis orthogonal and vertical to the propagation axis of said single-mode light guide, said stack of closed-loop resonators being optically coupled to said single-mode light guide, said stack of closed-loop resonators having an effective propagation loss; and
(c) an actuating source coupled to said plurality of closed-loop resonators so as to vary the effective propagation loss in said stack of closed-loop resonators.

36. The apparatus of claim 35, wherein said actuating source is an electrical source.

37. The apparatus of claim 35, wherein said actuating source is an optically inducing signal.

38. The apparatus of claim 35, wherein said actuating source is a light scattering movable object sufficiently close to said ring resonator ti induce said light scattering.

39. The apparatus of claim 35, wherein said actuating source comprises another waveguide having a fluid coupled between said another waveguide and said ring resonator.

40. The apparatus of claim 35, wherein each closed-loop resonator in said stack of closed-loop resonators supports a single vertical mode.

41. The apparatus of claim 35, wherein at least one closed-loop resonator in said stack of closed-loop resonators supports more than one vertical mode.

42. The apparatus of claim 35, wherein said stack of closed-loop resonators comprises a plurality of identical closed-loop resonators.

43. The apparatus of claim 35, wherein said stack of closed-loop resonators comprises a plurality of non-identical closed-loop resonators.

44. The apparatus of claim 43, wherein said non-identical closed-loop resonators have different radii.

45. The apparatus of claim 43, wherein said non-identical closed-loop resonators have different indices of refraction.

46. The apparatus of claim 43, wherein said non-identical closed-loop resonators have different thicknesses.

47. A method for modulating light, the method comprising:
(a) transmitting the light down a single-mode waveguide;
(b) optically coupling the light into a closed-loop resonator that exhibits an effective propagation loss; and
(c) varying the effective propagation loss in the closed-loop resonator or varying the coupling between said single mode waveguide and said closed-loop resonator.

48. The apparatus of claim 47 wherein said variation is performed by applying an electrical source to modify the coupling between said single mode waveguide and said closed-loop stack resonator.

49. The apparatus of claim 47 wherein said variation is performed by applying an optical source to modify the coupling between said single mode waveguide and said closed-loop stack resonator.

50. The apparatus of claim 47 wherein said variation is performed by applying a liquid medium between another waveguide and said closed-loop closed-loop stack resonator.

51. An apparatus comprising:
(a) a single-mode waveguide;
(b) a closed-loop resonator optically coupled to said single-mode waveguide, said ring resonator having an effective propagation loss; and
(c) means applied to said ring resonator for varying the effective propagation loss in said closed-loop resonator.

52. The apparatus of claim 51 wherein said means for varying comprises an electrical source coupled to said ring resonator.

53. An apparatus comprising:
(a) a single-mode waveguide;
(b) a plurality of closed-loop resonators forming an array along said single-mode light guide, and optically coupled to said single-mode light guide, each closed-loop resonator in said plurality of closed-loop resonators having an effective propagation loss; and
(c) means coupled to at least one of said plurality of closed-loop resonators for varying the effective propagation loss in said closed-loop resonator.

54. The apparatus of claim 53 wherein said means for varying comprises an electrical source coupled to said ring resonator.

55. An apparatus comprising:
(a) a single-mode waveguide with a propagation axis;
(b) a stack of closed-loop resonators having a longitudinal axis orthogonal and vertical to the propagation axis of said single-mode light guide, said stack of closed-loop resonators being optically coupled to said single-mode light guide, said stack of closed-loop resonators having an effective propagation loss; and
(c) means coupled to said plurality of closed-loop resonators for varying the effective propagation loss in said stack of closed-loop resonators.

56. The apparatus of claim 55, wherein said means for varying comprises an electrical source.
